(19) United States
(12) Patent Application Publication
(10) Pub. No.: US 2013/0101855 A1
(43) Pub. Date: Apr. 25, 2013

(54) BARRIER PAPER PACKAGING AND PROCESS FOR ITS PRODUCTION

(71) Applicant: FRITO-LAY NORTH AMERICA, INC., Plano, TX (US)

(72) Inventors: Pak Meng CHAM, Plano, TX (US); Todd FAYNE, Dallas, TX (US); Kenneth Scott LAVERDURE, Plano, TX (US); Deepali PALTA, Dallas, TX (US)

(73) Assignee: FRITO-LAY NORTH AMERICA, INC., Plano, TX (US)

(21) Appl. No.: 13/669,120

(22) Filed: Nov. 5, 2012

Related U.S. Application Data
(63) Continuation-in-part of application No. 13/277,974, filed on Oct. 20, 2011.

(51) Int. Cl. B32B 9/06; B32B 19/04; B32B 27/10; B32B 9/02; B32B 27/36; B32B 29/00; B32B 27/40; B32B 38/00; B32B 27/38

(52) U.S. Cl. CPC B32B 9/06; B32B 38/00; B32B 38/145; B32B 19/046; B32B 27/10; B32B 27/38; B32B 27/36; B32B 29/002; B32B 27/40; B32B 9/02
USPC 428/413; 156/280; 156/277; 428/537.5; 428/481; 428/452; 428/512; 428/486; 428/537.7; 428/448; 428/425.1

(57) ABSTRACT

The present invention is directed towards a paper-based composite packaging structure comprising a paper layer and a filler layer which may be laminated or otherwise adhered to the paper layer. In certain embodiments, the filler layer comprises a polymer or bio-based polymer. An optional barrier layer may be deposited on to one side of the paper layer or filler layer as desired to provide functional barrier characteristics. The composite paper-based film structure(s) may comprise additional layers such as one or more optional primer layers, adhesive layers, ink layers, and/or sealant layers that can be incorporated into the composite film structure as desired to enable the required functional characteristics of the composite film structure described herein. The paper-based composite packaging structure is substantially compostable and/or recyclable as both the paper and the bio-based polymer filler layers will break down under composting conditions and/or meet standardized recyclability requirements.

### CROSS-REFERENCED TO RELATED APPLICATIONS

This application is a continuation-in-part application and claims the benefit of and priority to co-pending U.S. patent application Ser. No. 13/277,974, entitled “Metallized Paper Packaging Film and Process for its Production,” filed on Oct. 20, 2011, the disclosure of which is hereby incorporated by reference.

### BACKGROUND OF THE INVENTION

The present invention relates to a paper-based flexible packaging material having acceptable barrier properties for packaging food products and to a method for making such packaging structures.

### DESCRIPTION OF RELATED ART

Multi-layered film structures made from petroleum-based products originating from fossil fuels are often used in flexible packages where there is a need for advantageous barrier, sealant, and graphics-capability properties. Barrier properties in one or more packaging layers are important in order to protect the product inside the package from light, oxygen and/or moisture. Such a need exists for the protection of foodstuffs, which may run the risk of flavor loss, staling, or spoilage if sufficient barrier properties are not present to prevent transmission of light, oxygen, or moisture into the package. A graphics capability is typically desired so as to enable a consumer to quickly identify the product that he or she is seeking to purchase and which also provides food product manufacturers with the ability to provide label information, such as the nutritional content of the packaged food, and pricing information, such as bar codes, on the product packaging.

Flexible packaging used in the prior art typically comprises layers of petroleum-based resin sheets such as oriented polypropylene (“OPP”) or polyethylene terephthalate (“PET”). When resin films do not provide adequate barrier properties, a barrier layer may be deposited on the surface of one of the inner layers of the multi-layer film. For example, a metal layer deposited upon an inner base layer can provide the required barrier properties. It is well known in the prior art that metalizing a petroleum-based polyolefin such as OPP reduces the moisture and oxygen transmission through the film by several orders of magnitude.

Petroleum-based prior art flexible films comprise a relatively small part of the waste produced when compared to other types of packaging. Thus, it is uneconomical to recycle them because of the energy required to collect, separate, and clean the used flexible film packages. Another drawback of using petroleum films in food packaging arises from their resistance to environmental and/or biological degradation. Consequently, discarded packages that become dislocated from intended waste collection streams appear as unsightly litter for a relatively long period of time. Moreover, even if such waste packaging is collected in the sanitation stream and landfilled, such petroleum-based films typically survive for long periods of time with little degradation. Another disadvantage of petroleum-based films is that they are made from petroleum-based constituents, which many consider to be a limited, non-renewable resource.

Consequently, a need exists for a degradable and/or recyclable, flexible packaging made from a renewable resource, which retains desirable barrier properties. Such flexible packaging should be food safe and have the requisite barrier properties to store a low moisture shelf-stable food for an extended period of time without product staling. The flexible packaging should have the requisite sealing and coefficient of friction properties that enables it to be used on existing vertical form, fill, and seal machines. The flexible packaging should be capable of being recycled in existing recycle streams and/or be compostable.

### SUMMARY OF THE INVENTION

One embodiment of the present invention is directed towards a paper-based composite packaging structure and method for making a paper-based composite packaging structure comprising a paper layer and a filler layer which may be laminated or otherwise adhered to the paper layer. In certain embodiments, the filler layer comprises a polymer or bio-based polymer. An optional barrier layer may be deposited on to one side of the paper layer or filler layer as desired to provide functional barrier characteristics. In other contemplated embodiments, the composite paper-based film structure(s) may comprise additional layers such as one or more optional primer layers, adhesive layers, ink layers, and/or sealant layers that may be incorporated into the composite film structure as desired to enable the required functional characteristics of the composite film structure described herein.

In one embodiment of the present invention, a paper-based composite packaging structure and method for making a paper-based composite packaging structure comprises a primer layer comprising a silica layer deposited on to a filler layer comprising polyhydroxyalkonoate (PHA) polymer, polylactic acid (PLA) polymer or other bio-polymer which is applied on to a paper layer via conventional extrusion or coating techniques as known in the art. An optional sealant layer may also be applied to one side of the paper layer for sealing capability. Alternative embodiments of the present invention include the application of additional optional metal, metalloid, polyethylene-vinyl alcohol (PVOH), polyglycolic acid (PGA), ethylene-vinyl alcohol (EVOH), polyvinylidene chloride (PVDC), amorphous PLA (aPLA), wax, starch and/or ink layers applied to, laminated, coated, deposited or otherwise adhered or interfaced with the composite film structure described above.

In one embodiment of the present invention, a paper-based composite film and method for making a paper-based composite film comprises a monoweb including a primer layer, a PHA layer, and a paper layer. Alternative embodiments include additional optional layers comprising a metal, metalloid, PGA, PVDC, amorphous PLA, PHA, wax, polyester and co-polyester, adhesives, sealants and/or ink layers applied to, laminated, coated, deposited or otherwise adhered or interfaced with composite film structure described above.

In one embodiment of the present invention, a paper-based composite film and method for making a paper-based composite film comprises a paper layer and a PGA layer deposited on at least one side of the paper layer. Alternative embodiments include additional optional layers comprising primers, sealants, adhesives, inks and/or barrier layers applied to, laminated, coated, deposited or otherwise adhered or interfaced with the composite film structure described above.

In one embodiment of the present invention, a paper-based composite film and method for making a paper-based composite film comprising an ink layer, a starch layer, and a paper layer. Alternative embodiments include additional optional layers comprising a metal, metalloid, polyester, copolyester, PGA, amorphous PLA, PHA, wax, polyester and co-polyester, and/or layers applied to, laminated, coated, deposited or otherwise adhered or interfaced with composite film structure described above.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a magnified schematic cross-section of a multi-layer flexible packaging made according to one embodiment of the invention;

FIG. 2 depicts a magnified schematic cross-section of a multi-layer flexible packaging according to one embodiment of the invention; and,

FIG. 3 depicts a magnified schematic cross-section of a multi-layer flexible packaging according to one embodiment of the invention.

### DETAILED DESCRIPTION

The present invention is directed towards a recyclable and/or compostable paper-based multi-layer composite packaging. In various disclosed embodiments, the paper-based composite packaging structure is compostable and/or recyclable as both the paper and the bio-based polymer filler layers will break down under composting conditions and/or meet recyclability requirements. The paper-based composite structure is suitable for reutilization in typical paper recycling processes as described below.

Paper-based articles are typically recycled by using mechanical re-pulping processes. As such, any polymer used in conjunction with a paper-based article must be compatible with current mechanical re-pulping processes. Paper may also undergo chemical re-pulping processes prior to mechanical re-pulping. Chemical re-pulping typically employs the use of caustic soda, bleaching agents, or other chemicals to dissolve or otherwise remove contaminates or polymer coatings from the paper surface. When polyethylene (PE) or polypropylene (PP) is coated onto a paper surface, the polymers will bind to the paper fibers and when separated out by mechanical re-pulping processes, typically result in the loss of more than 15% paper fiber by weight as the polymer sticks to and takes some of the paper fiber with it in the processing waste stream during the re-pulping process. Most paper mills will refuse to take polymer-coated paper for recycling operations for this reason.

The caustic wash of the re-pulping process will not degrade polyethylene and other polyolefins due to their high chemical resistance. However, PGA, PHA, PLA and other bio-based polymers become solubilized under depolymerization conditions for condensation polymers, which leave the chemical linkages between polymers vulnerable to chemical attack by NaOH and other agents. The polymerization of PGA, aPLA and PHA polymer results in the removal of water molecules from the resulting chemical structure. However, this chemical reaction is reversible by the addition of water to the polymerized polymer. Therefore, the addition of water, heat (to provide energy), and chemical agents (e.g. NaOH) during the repulping process works to remove the polymer or at least reduce the paper fiber loss compared with polyethylene and polypropylene. Some compostable polymers that are not renewably resourced may also be used with the present invention, such as aliphatic polyesters that contain linkages that are biologically accessible and degradable.

In the various disclosed embodiments herein, the present invention reduces the amount of material required to provide a paper-based flexible packaging with barrier properties. The present invention is thus directed to a paper-based flexible packaging with a multi-layer structure comprising a paper layer, a filler layer, a primer layer, and/or a barrier layer formed into a paper-based flexible composite film. Optionally, the multi-layer packaging structure may include an adhesive layer, a sealant layer, and/or an ink layer. The inventive embodiments described herein enable the use of flexible paper-based food packaging structures sufficient to be used as a packaging material for the storage of low-moisture, shelf-stable food and snack products. In certain embodiments, such paper based flexible packaging provides a flexible food and snack packaging that is recyclable and/or compostable.

As used herein, the term “package” or “packaging” should be understood to include any container constructed of flexible multi-layer packaging. Such desired package or packaging provides oxygen barrier properties with an oxygen transmission rate of less than about 10 cc/m²/day, preferably less than about 5 cc/m²/day, and more preferably less than about 2 cc/m²/day. Such desired package or packaging provides moisture barrier properties measured by a water vapor transmission rate of less than about 1.0 grams/m²/day, preferably less than about 0.5 grams/m²/day, and more preferably less than about 0.1 grams/m²/day. The packaging materials discussed herein are particularly suitable for forming flexible packages for snack foods such as potato chips, corn chips, tortilla chips and the like. However, while the layers and various structures discussed herein are contemplated for use in processes for the packaging of snack foods, such as the filling and sealing of bags of snack foods, the packaging structures disclosed herein may also be put to use in various process and product packaging for other low moisture products.

In the past, typical obstacles encountered by practitioners in the art who were attempting to apply a barrier layer to a paper substrate arose from the structure of the paper itself. During the paper manufacturing process, individual fibers (typically made of plant-based materials) are pressed together and dried to form flexible sheets of paper. When the surface topology of a sheet of paper is analyzed using a crude method, such as optical microscopy, the paper sheet is seen as a network of linked fibers. Instead of a solid sheet, paper is a porous structure made of pressed and bounded cellulosic fibers. The porosity of paper is defined as the volume fraction of all voids existing within a sheet of paper and may be measured with known the air pressure testing method as outlined in IPC TECHNICAL PAPER SERIES NUMBER 183 (http://smartech.gatech.edu/jspui/bitsteam/1853/2665/1/tps-183.pdf) or with TAPPI methods T460 (low air resistance) and T536 (high air resistance). As untreated is a highly porous material, the porosity of paper must be reduced to the level of polymer and plastic films to even be thought of as a plausible barrier to gases and vapors. Fillers and sizing agents will greatly reduce the porosity of paper to where a continuous surface is present. This technology has traditionally been employed to produce higher quality print surfaces. The same techniques will produce a paper surface of similar quality to low grade or commodity polymers films. These filled paper surfaces or low-quality polymer films exhibit surfaces of high roughness when viewed with a sensitive or high-magnification measuring device, such as an atomic force microscope (AFM) or a scanning electron microscopy (SEM). The rough surface of the filled fiber surface can be clearly seen. The filled fibers are revealed as peaks or plateaus and the space between the filled fibers appears as valleys or canyons which together result in a highly variable, rough surface topology. The surface roughness of a paper layer, as used herein, is calculated as the average value of the elevation differential between the peaks and valleys found on the surface of the paper layer. Roughness measurements using the root mean square method can be made using the images taken with these atomic force or optical microscopes as known in the art.

Past attempts to apply a barrier layer to a sheet of paper have generally failed to produce a packaging structure capable of providing acceptable barrier properties. This is primarily due to the high porosity of paper. Sizing and other agents reduce the porosity of paper until it becomes a suitable foundation for the addition of barrier layers. Once the paper is transformed to a continuous surface, reduction of the surface roughness to acceptable levels is the next step in creation of a barrier paper. For purposes of various embodiments of the invention disclosed herein, paper of suitably low porosity will be paper with a Gurley Time of 200 second or greater for 10 ml of air to pass through as described in TAPPI method T536. This assures the paper has a continuous surface suitable for the application of additional layers to obtain gas and vapor barrier. The continuity of the surface may also be verified by optical microscopy, AFM, or SEM.

During past attempts to apply a barrier layer to a sheet of paper, the high surface roughness of the paper surface (i.e. the elevation difference in height between the peaks and valleys of the filled paper substrate) resulted in the deposited barrier particles building up on the “peaks” which inhibited uniform deposition of barrier particles in the “valleys” of the paper structure. Thus, while some barrier particles may adhere to the valley portions of the paper surface, it remained difficult to obtain adequate uniform depth and continuous barrier layer deposition coverage between the paper substrate mesh peaks and valleys which would provide acceptable barrier properties for a paper-based flexible packaging. The barrier layer coverage issue is especially acute when the height difference between the peaks and valleys of the paper mesh, or the distance between adjacent peaks, is greater than the desired thickness of the barrier layer (typically 40 nanometers or less).

It has been determined in the development of the invention disclosed herein that an effective barrier layer may be applied to a paper substrate if the surface of the paper is substantially smoothed or filled before the barrier layer is applied. In one embodiment, a paper layer that comprises a surface roughness greater than the desired thickness of the barrier layer being applied to that surface is smoothed to produce a surface roughness that is less than the desired thickness of the barrier layer. In one embodiment, the surface roughness of the smoothed paper is less than half the desired thickness of the barrier layer.

As used herein, the term “barrier” refers to any suitable moisture and oxygen barrier material for reducing or substantially eliminating the transmission of oxygen and water vapor through the packaging structure. A barrier layer may comprise, including but not limited to, a metal, metal oxide, metalloid oxide, and/or combinations thereof. Such barrier layer may be applied by any suitable barrier application method as known in the art, including, but not limited to evaporation, sputtering, chemical vapor deposition (CVD), combustion chemical vapor deposition (CCVD), physical vapor deposition (PVD), plasma enhanced chemical vapor deposition (PECVD), vacuum deposition, flame deposition, and flame hydrolysis deposition. In alternative embodiments described herein, existing coating technologies which are capable of providing sufficient barrier properties may also be used to provide a barrier layer, such as the application of PVDC, EVOH, PVOH or various known acrylics such as polyethylene acrylic acid (EAA), polymethyl methacrylate (PMMA), polyacrylic acid, polycyanacrylate, hydroxyethyl methacrylate, and polyethyl methacrylate to form an effective barrier layer.

One method available to smooth the surface of a paper substrate is to apply a filler layer on the paper surface. Examples of fillers that can be applied to a paper substrate include chalky clays, such as kaolinite, talc, mica, mordenite, vermiculite, titanium dioxide and calcium carbonate. The filler can be bound to the paper surface using natural or synthetic binders, such as waxes, starches, vinyls, acrylics, proteins or latex. The filler may also contain dispersants to aid in particle separation, defoamers for removing froth from pigmented filers, insolubilizers for improving water resistance, preservatives for reducing bacterial growth, lubricants for reducing the coefficient of friction of the paper and/or polymer resins.

By applying a filler to the paper surface, the resulting paper has a smoother surface than the paper had prior to the application of the filler. In various disclosed embodiments, the filler may also act as a primer layer increasing the surface energy of the paper layer surface to be coated thereby increasing the bond strength of the barrier layer to the primed paper layer of the composite packaging structure. In various disclosed embodiments, the filler comprises a bio-based polymer that is substantially compostable. As used herein, the term “bio-based polymer” means a polymer where at least 80% of the polymer by weight is derived from a non-petroleum feedstock. In one embodiment, up to about 20% of the bio-based polymer may comprise a conventional polymer sourced from petroleum.

Table 1 discloses various materials and resins that may be used in the construction of the various packaging embodiments of the invention described herein and their respective eligibility for composting and/or recycling operations. The composting environment is further delineated into the marine environment and typical residential or “home” composting environment. Composting is generally known as the process of decomposing organic matter into compost or humus, which is rich in soil and plant nutrients. Compost may be used as a soil conditioner, plant and soil fertilizer, and as a natural soil pesticide.

Recycling generally refers to the ability to process used materials or waste into new products to prevent the waste of such potentially reusable materials. Recycling reduces the consumption of new raw materials, reduces energy usage and environmental pollution associated with product manufacturing operations. Recycling is a key component in modern waste reduction. The construction of a paper-based food packaging with one or more of the materials described herein would result in minimizing litter, would decrease the landfill volume occupied by such waste packaging, and would be partially or completely compostable, recyclable or both as depicted by the various material resins in Table 1. As shown in Table 1, the terms “Y” and “N” represent “yes” and “no,” respectively.

TABLE 1

| | | | Marine | Home | |
|---|---|---|---|---|---|
| | Bio- | Compost- | Compost- | Compost- | Recy- |
| Material/Resin | Based | able | able | able | clable |
| Paper | Y | Y | Y | Y | Y |
| PLA | Y | Y | N | N | N |
| PHA | Y | Y | Y | Y | N |
| ECOFLEX | N | Y | N | N | N |
| ECOVIO | Partially | Y | N | N | N |
| HDPE | N | N | N | N | Y |
| LDPE | N | N | N | N | N |
| PP | N | N | N | N | N |
| PET | N | N | N | N | N |
| PGA | N | Y | Y | Y | N |
| EVOH | N | N | N | N | N |
| PVOH | N | Y | N | Y | N |
| PVDC | N | N | N | N | N |
| EAA | N | N | N | N | N |
| PMMA | N | N | N | N | N |
| Polyacrylic | N | Y | N | Y | N |
| Acid (PAA) | | | | | |
| Polycyanacrylate | N | N | N | N | N |
| Hydroxyethyl | N | N | N | N | N |
| Methacrylate | | | | | |
| Polyethyl | N | N | N | N | N |
| Methacrylate | | | | | |
| (PEMA) | | | | | |
| PBS | Y | Y | Y | Y | N |

Examples of bio-based, compostable and/or recyclable polymers which may be used as a filler in the embodiments disclosed herein are depicted in Table 1 and described in greater detail herein. For example, PLA is made from plant-based feedstock including soybeans, as illustrated by U.S. Patent Application Publication Number 2004/0229327 or from the fermentation of agricultural by-products such as corn starch or other biomass feedstock such as corn stover, wheat, or sugar beets. PLA may be processed like most thermoplastic polymers into a film. PLA has physical properties similar to PET and has excellent clarity. PLA films are described in U.S. Pat. No. 6,207,792 and PLA resins are commercially available from vendors such as Natureworks LLC (http://www.natureworksllc.cm) of Minnetonka, Minn. PLA degrades into carbon dioxide and biomass. PLA films used in accordance with the present invention are substantially insoluble in water under ambient conditions, but will readily degrade under typical composting conditions.

PHA is a polymer belonging to the polyesters class and may be produced by microorganisms (i.e. Alcaligenes eutrophus) as a form of energy storage. In one embodiment, microbial biosynthesis of PHA starts with the condensation of two molecules of acetyl-CoA to give acetoacetyl-CoA which is subsequently reduced to hydroxybutyryl-CoA. Hydroxybutyryl-CoA is then used as a monomer to polymerize PHB, a common type of PHA. PHA is commercially available from various vendors such as Metabolix of Cambridge, Mass. In various embodiments disclosed herein, PHA may be used as a filler layer, a barrier layer and/or sealant layer in the paper-based flexible composite packaging structures described herein.

PGA is a degradable thermoplastic polyester polymer that is compostable and compatible with mechanical repulping processes associated with paper recycling operations. PGA is commercially available from Kureha of Japan which manufactures and sells PGA under the trademark KUREDUX. In certain embodiments, PGA may also be used as a filler layer, an oxygen barrier layer and/or sealant layer in the paper-based flexible composite packaging structures described herein.

Table 2 provides a listing of various embodiments of the invention depicting multiple flexible packaging structures incorporating a paper layer as described herein. As used in accordance with the present invention, such composite packaging structures are substantially insoluble in water under ambient conditions, but will readily degrade under typical composting conditions. For reference, the packaging structure elements are to be read from left to right connoting that the left most layer of the packaging composite is exposed to the exterior environment while the right most layer is exposed to the interior environment or product side of the package.

TABLE 2
Packaging Structures (Monoweb with No Ink Layer)

| | |
|---|---|
| 1-A | [SiO(x)]/X/Paper |
| 1-B | [SiO(x)]/PHA/Paper/PHA |
| 1-C | [SiO(x)]/X/Paper/X/Sealant |
| 1-D | [Al(2)O(3)]/X/Paper |
| 1-E | [Al(2)O(3)]/X/Paper/X |
| 1-F | [Al(2)O(3)]/X/Paper/X/Sealant |
| 1-G | [SiO(x)]/X/PVDC/Paper |
| 1-H | [SiO(x)]/X/PVDC/Paper/X |
| 1-I | [SiO(x)]/X/PVDC/Paper/X/Sealant |
| 1-J | [SiO(x)]/X/PVDC/Paper |
| 1-K | [SiO(x)]/X/PVDC/Paper/X |
| 1-L | [SiO(x)]/X/PVDC/Paper/Sealant |
| 1-M | [Al(2)O(3)]/X/PVDC/Paper |
| 1-N | [Al(2)O(3)]/X/PVDC/Paper/X |
| 1-O | [Al(2)O(3)]/X/PVDC/Paper/X/Sealant |

Packaging Structures (Monoweb with an Ink Layer)

| | |
|---|---|
| 1-P | [SiO(x)]/Ink/X/Paper |
| 1-Q | [SiO(x)]/Ink/X/Paper/X |
| 1-R | [SiO(x)]/Ink/X/Paper/X/Sealant |
| 1-S | [Al(2)O(3)]/Ink/X/Paper |
| 1-T | [Al(2)O(3)]/Ink/X/Paper/X |
| 1-U | [Al(2)O(3)]/Ink/X/Paper/X/Sealant |
| 1-V | [SiO(x)]/Ink/X/PVDC/Paper |
| 1-W | [SiO(x)]/Ink/X/PVDC/Paper/X |
| 1-X | [SiO(x)]/Ink/X/PVDC/Paper/X/Sealant |
| 1-Y | [Al(2)O(3)]/Ink/X/PVDC/Paper |
| 1-Z | [Al(2)O(3)]/Ink/X/PVDC/Paper/X |
| 1-AA | [Al(2)O(3)]/Ink/X/PVDC/Paper/X/Sealant |

Packaging Structures (Laminated Barrier Layer)

| | |
|---|---|
| 1-BB | Ink/Paper/Adhesives/[SiO(x)]/X/Paper/X |
| 1-CC | Ink/Paper/Adhesives/[SiO(x)]/X/Paper/X/Sealant |
| 1-DD | Ink/Paper/Adhesives/[SiO(x)]/X/Paper/Sealant |
| 1-EE | Ink/Paper/Adhesives/[Al(2)O(3)]/X/Paper/X |
| 1-FF | Ink/Paper/Adhesives/[Al(2)O(3)]/X/Paper/X/Sealant |
| 1-GG | Ink/Paper/Adhesives/[Al(2)O(3)]/X/Paper/Sealant |

Packaging Structures (Metallization Primer Layer)

| | |
|---|---|
| 1-HH | Ink/Paper/Adhesives/Metalized Layer/[SiO(x)]/X/Paper/X |
| 1-II | Ink/Paper/Adhesives/Metalized Layer/[SiO(x)]/X/Paper/ |
| | X/Sealant |
| 1-JJ | Ink/Paper/Adhesives/Metalized Layer/[SiO(x)]/X/Paper/ |
| | Sealant |
| 1-KK | Ink/Paper/Adhesives/Metalized Layer/[Al(2)O(3)]/X/Paper/X |
| 1-LL | Ink/Paper/Adhesives/Metalized Layer/[Al(2)O(3)]/X/Paper/ |
| | X/Sealant |
| 1-MM | Ink/Paper/Adhesives/Metalized Layer/[Al(2)O(3)]/X/Paper/ |
| | Sealant |

As depicted in Table 2, the symbol “[SiO(x)]” represents a silica layer which has been deposited as a primer or barrier layer via CCVD or PECVD or as is otherwise known in the art and/or described herein. In certain embodiments, the silica layer is deposited as a primer or barrier layer via CCVD or PECVD at open atmosphere. The symbol “[Al(2)O(3)]” represents an alumina layer which has been deposited as a primer or barrier layer via conventional metallization, CCVD or PECVD, or as is otherwise known in the art. In certain embodiments, the alumina and/or silica layer is deposited via CCVD or PECVD at open atmosphere. The symbol “X” represents the various polymers which may be utilized as one or more filler layers including, but not limited to, PLA, PHA, PGA, and others as known in the art. The acronym “PVDC” represents a polyvinylidene chloride layer which can provide additional barrier layer functionality as described in various disclosed embodiments herein. The term “Adhesives” represents solvent based adhesives such as polyvinyl acetate, hot melt adhesives such as ethylene-vinyl acetate, or solventless adhesives such as polyurethanes. The term “Ink” represents any commercially available printing ink(s) which may be utilized for printing packaging in the food packaging context. The term “Paper” refers to any paper substrate such as Kraft paper, coated papers, magazine or photographic paper, or other cellulosic pulp based papers which are commercially available, and paper structures that are treated as standard practice in the paper industry, such as with calendaring or machine glazed, for improved surface smoothness. The term “Sealant” is used to refer to a sealant layer, including but not limited to a “heat seal” layer, which may be formed from PHA, amorphous PLA, wax, starches, PGA, and/or commercially available sealants such as ECOFLEX or ECOVIO, which is a compostable polyester manufactured by BASF. The heat seal layer may also employ heat seal promoters as known in the art to increase the heat seal strength and temperature sealing range and which are commercially available. Table 2 discloses various structural configurations of the packaging composites including monoweb with no ink layer (Structures 1-A through 1-O), monoweb with an ink layer (Structures 1-P through 1-AA), structures with a laminated barrier layer (Structures 1-BB through 1-GG) and structures with a metallization primer layer (Structures 1-HH through 1-MM).

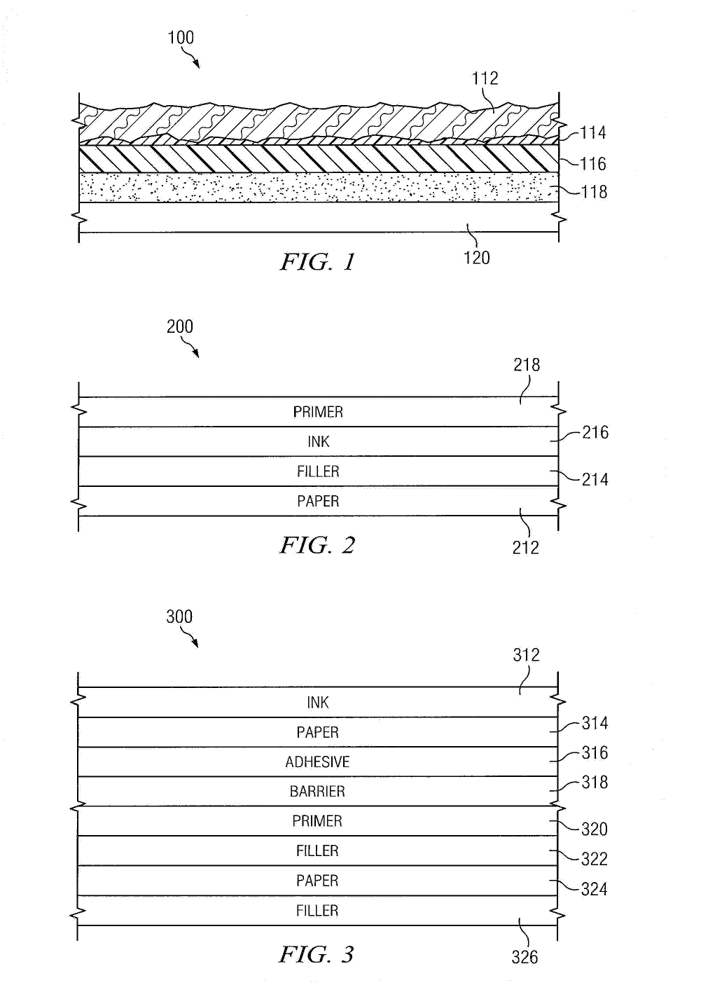

FIG. 1 is a magnified cross section of one embodiment of a paper-based flexible packaging 100 of the present invention. As shown therein, paper layer 112 is coated on one side by filler layer 114. Optional primer layer 116 may be deposited on the side opposite the coated paper layer 112 as shown to increase the surface energy so as to promote increased bonding with optional barrier layer 118. Barrier layer 118 can be applied by any suitable barrier application method as known in the art, including, but not limited to evaporation, sputtering, chemical vapor deposition (CVD), combustion chemical vapor deposition (CCVD), physical vapor deposition (PVD), plasma enhanced chemical vapor deposition (PECVD), vacuum deposition, flame deposition, and flame hydrolysis deposition. In alternative embodiments, barrier layer 118 may be applied via CCVD or PECVD at open atmosphere without the need for a vacuum or pressure chamber. In alternative embodiments, conventional Mayer rod, Gravure and other known coating techniques may be utilized to deposit a primer layer to promote adhesion of the barrier layer to the paper layer, to smooth the surface of the paper layer to improve the deposition of the barrier layer, and/or to provide a barrier layer functionality. Optional heat seal layer 120 is shown which acts to seal the flexible packaging as processed through standard vertical form filling sealing machines (VFFS) and other known packaging equipment.

In alternative embodiments, known coating technologies which are capable of providing sufficient barrier properties may also be used to provide barrier layer 118, such as application of polyvinylidene chloride (PVDC), ethylene-vinyl alcohol (EVOH), polyethylene-vinyl alcohol (PVOH) or various known acrylics such as polyethylene acrylic acid (EAA), polymethyl methacrylate (PMMA), polyacrylic acid, polycyanacrylate, hydroxyethyl methacrylate, and polyethyl methacrylate to form barrier layer 118 via application methods as known in the art and/or described herein.

In one embodiment as shown in FIG. 1, primer layer 116 is applied as a solution comprising EAA and PVOH that is coated in liquid form on to a surface of paper layer 112 and then dried so as to smooth said paper surface 112. For example, the solution may comprise 0.1-20% PVOH and EAA and 80-99.9% water. In one embodiment, roughly equal amounts of PVOH and EAA are used. In one embodiment, the solution comprises about 90% water, about 5% PVOH, and about 5% EAA. Such process provides a smoothed and/or energized primer layer 116 for improving the deposition and adhesion of barrier layer 118. Optional heat seal layer 120 may also be provided. In one embodiment, heat seal layer 120 comprises amorphous PLA, such as a 4060 PLA available from Natureworks. Optional ink layer may be printed on a side of the paper layer opposite the filler and primer layers. In alternative embodiments, the ink layer may be printed on a side of the filler layer opposite the barrier layer. The ink layer may comprise a product logo, graphics, nutritional information, or other printed materials.

In one embodiment, primer layer 116 comprises an EVOH formula that can range from a low hydrolysis EVOH to a high hydrolysis EVOH. Below depicts EVOH formulae in accordance with various embodiments of the present invention.

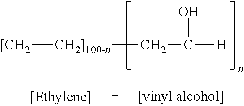

As used herein a low hydrolysis EVOH corresponds to the above formula where n=25. As used herein, a high hydrolysis EVOH corresponds to the above formula where n=80, wherein “n” is the mole percentage of vinyl alcohol in the composition. Primer layer 116 comprising the EVOH formula may be extrusion coated onto the smooth paper surface, and barrier layer 118 can be applied by methods known in the art and listed above. In other embodiments of the invention described herein, primer layer 116, 214, 320 as depicted in FIGS. 1, 2, and 3 may comprise one of a PVOH or an amorphous PVOH coating that is applied to a filler side of the paper as a liquid and then dried prior to application of an optional barrier layer. Barrier layer 118, 318 may then be applied to primer layer 116, 320 as shown in FIGS. 1 and 3.

In one embodiment, a composite packaging structure comprising a bio-film and paper structure is constructed wherein the PHA layer functions as both a filler and sealant. The paper and PHA layers may be laminated together by using standard industry processes such as extrusion lamination, extrusion coating, curtain coating, aqueous coating, solvent adhesives, polyurethane adhesives and/or solvent-less adhesives as known in the art. Optionally, the PHA layer surface opposite the paper surface may be coated with amorphous PVOH, PVOH, EVOH, maleic anhydride or other suitable coatings sufficient to impart sufficient barrier characteristics to the PHA layer for food packaging uses.

In one embodiment, the filler layer does not function as an adhesion layer. Instead, a primer layer is extrusion coated over the surface of the paper before the barrier layer is applied. The primer layer is comprised of a suitable material that has polar chemical groups and also functions as a surface modifier that provides a substantially smooth surface and/or improves the surface energy for application and retention of a barrier layer, such as barrier layer 118 shown in FIG. 1. Examples of suitable primer materials that may be used in accordance with various embodiments of the present invention include, but are limited to, an epoxy, maleic anhydride, ethylene methacrylate (“EMA”), polyethylenimine (“PEI”) and ethylene vinyl acetate (“EVA”).

Various structural embodiments of the flexible composite packaging disclosing the use of a paper substrate, PGA, amorphous PLA (aPLA), PVOH and/or wax in various structural embodiments are set forth in Table 3. For reference, as the packaging structure elements are read from left to right, the left most layer of the packaging composite is exposed to the exterior environment while the right most layer is exposed to the interior environment or product side of the package.

TABLE 3
Packaging Structures

| | |
|---|---|
| 2-A | Ink/Paper/PGA |
| 2-B | Ink/Paper/PGA/Sealant |
| 2-C | Ink/Paper/PGA/Adhesive or Lamination/Sealant |
| 2-D | [SiO(x)]/Ink/Paper/PGA |
| 2-E | [SiO(x)]/Ink/Paper/PGA/aPLA |
| 2-F | [SiO(x)]/Ink/PGA/Paper/Sealant |
| 2-G | [SiO(x)]/Ink/aPLA/Paper/PGA/aPLA |
| 2-H | [Al(2)O(3)]/Ink/Paper/PGA |
| 2-I | [Al(2)O(3)]/Ink/Paper/PGA/aPLA |
| 2-J | [Al(2)O(3)]/Ink/PGA/Paper/Sealant |
| 2-K | [Al(2)O(3)]/Ink/aPLA/Paper/PGA/aPLA |
| 2-L | Ink/Paper/PGA/[SiO(x)]/Sealant |
| 2-M | Ink/Paper/PGA/[Al(2)O(3)]/Sealant |
| 2-N | Ink/Paper/PVOH/[SiO(x)]/Sealant |
| 2-O | Ink/Paper/PVOH/[Al(2)O(3)]/Sealant |
| 2-P | Ink/Paper/Wax/[SiO(x)]/Sealant |
| 2-Q | Ink/Paper/Wax/[Al(2)O(3)]/Sealant |
| 2-R | Ink/Paper/Wax/Al-Metal/Sealant |

As described in Table 3, the symbol [SiO(x)] represents a silica layer which has been deposited as a primer or barrier layer via CCVD or PECVD, or by other methods as is known in the art. In certain embodiments, the silica layer is deposited as a primer or barrier layer via CCVD or PECVD at open atmosphere. The symbol [Al(2)O(3)] represents an alumina layer which has been deposited on to the indicated surface as a primer or barrier layer via conventional metallization, CCVD or PECVD, or as is known in the art and/or described herein. In various embodiments, the silica and/or alumina layer is deposited via CCVD or PECVD at open atmosphere. The term “Ink” represents any commercially available printing inks which may be utilized for printing packaging in the food packaging context. The term “Paper” refers to any paper substrate such as Kraft paper, coated papers, magazine or photographic paper, or other cellulosic pulp based papers which are commercially available, and paper structures that are treated with standard practice in the paper industry, such as with calendaring or machine glazed, for improved surface smoothness. The term “Sealant” is used to refer to a sealant layer or “heat seal” layer which may be formed from polybutylsuccinate (PBS), PHA, aPLA, wax, starch, PGA, aliphatic polyester and/or commercially available sealants such as ECOFLEX or ECOVIO which is a compostable polyester manufactured by BASF. The heat seal surface may also employ heat seal promoters to increase the heat seal strength and temperature sealing range. The various structural configurations of the paper-based packaging composites disclosed in Table 3 include structures with paper and PGA (Structures 2-A through 2-M), structures with paper and PVOH (Structures 2-N through 2-O), and structures with paper and wax (Structures 2-P through 2-R).

FIG. 2 illustrates one embodiment of the composite paper-based packaging structure 200 as described herein. Composite paper structure 200 is shown with paper layer 212, filler layer 214, ink layer 216 and primer layer 218. In this embodiment, primer layer 218 comprises a silica layer or multiple silica layers deposited via CCVD or PECVD processes as are known in the art to form a high energy surface for application of a metal barrier layer (not shown) to primer layer 218. In an alternative embodiment, a [Al(2)O(3)] barrier layer is deposited in place of primer layer 218. Ink layer 216 is printed on to a surface of filler layer 214 wherein filler layer 214 may comprise PHA, PLA, PET, or any other suitable bio-based film layer in various embodiments. Filler layer 214 may be extrusion coated on to a surface of paper layer 212 by conventional extrusion methods as known in the art.

In one embodiment as depicted in FIG. 2, any polymer or polymer blend that processes similar to the bio-based film on an orientation line, that has a relatively smooth surface and polar chemical groups may be used as filler layer 214. Polar chemical groups are desirable in the filler because they are attracted to the metal or metalloid barrier layer and it is believed that polar chemical groups, such as hydroxyl groups, covalently bond to form a metal oxide or metalloid oxide upon metallization. Alcohol blends using an ethylene vinyl alcohol (EVOH) formulas and polyvinyl alcohol (PVOH) are desirable fillers as are polymers having polar amide groups such as nylon. Amorphous PET (aPET), polyethylene terephthalate glycol (PETG) and PGA having polar carbonyl groups can also be used as fillers. Consequently, in the various described embodiments, filler layer 214 may comprise one or more polar substrates selected from amorphous PET, PETG, aPET, PGA, various nylons including amorphous nylon, EVOH, nylon/EVOH blends, PVDC, PVOH, amorphous PVOH (aPVOH), and/or PVOH/ethylene acrylic acid (“EAA”) blends as is known in the art.

In one embodiment, a paper and PGA structure may be created using standard industry processes such as extrusion coating. The paper and PGA structure may also be created by producing a plastic film of PGA monolayer or a multi-layer co-extruded film containing an outer layer of PGA. This structure may be created by conventional cast film or blown film processes as known in the art. Example polymers which may be used in the co-extruded structures include polyesters such as PLA, ECOFLEX, ECOVIO and other potential polymer blends. The paper and PGA film may then be combined using currently known extrusion lamination techniques or adhesion lamination processes to form the paper/PGA structure. The PGA structure may consist of 100% PGA resin (such as Kureha PGA Grade-100E35) or PGA with fillers such as calcium carbonate or PGA formed with voids (foam films formed by chemical or physical processes during the film fabrication process).

### Example 1

PGA 100E35 with a thickness of 1.2 mil was extrusion coated on to two paper substrates. The paper substrates were (a) 25# wt. C1S paper from Verso and (b) 25# wt. Thilmany MG paper with a mica pre-coat H722 (1.7 gsm). Both samples were metallized using conventional vacuum metallization techniques. A PET film leader was used to control the level of metallization. The target optical density for the PET film was 2.3. The data results were as follows:

### Example 1

### Data Set

| Sample | WVTR (avg.) | OTR (avg.) |
|---|---|---|
| Description | g/m²/day | cc/m²/day |
| PGA 35 C1S Paper | 23.4 | — |
| PGA 35 C1S Paper | 1.01 | 10.2 |
| Metallized | | |
| PGA on Thilmany | 26.6 | — |
| Paper with | | |
| Michelman H722 | | |
| Base Coat | | |
| PGA on Thilmany | 0.97 | 10 |
| Paper with | | |
| Michelman H722 | | |
| Base Coat | | |
| Metallized | | |
| PET Leader | 1.3 | — |

### Example 2

PGA was co-extruded on to a PLA film for barrier potential testing. The PGA/PLA film was coextruded in a three layer configuration with PGA as the top most layer, a core of PLA (NatureWorks 4032), and a sealant PLA layer (NatureWorks 4060). The combined polymer structure was extruded through a die with a melt temperature of 440° F. The film was run through a set of chill rolls and oriented in the machine direction on a single stage machine direction orientation (MDO) unit. The film was then processed through a transverse direction orientation unit employing chain spreaders and an oven. The film was then slit and rewound to the desired width and length and certain specimens were metallized. The following data results were generated:

### Example 2

| | | | WVTR, | WVTR, | |
|---|---|---|---|---|---|
| | | WVTR, | g/m²/day | g/m²/day | OTR, |
| Sample | | g/m²/day | (Summer | (Super- | cc/m²/day |
| No. | Sample | (Tropical) | Warehouse) | market) | (Standard) |
| 1 | Unmetallized | 110.4 | 39.3 | 15.8 | 19.1 |
| | PGA/PLA | | | | |
| | A/PLA B | | | | |
| 2 | Metallized | 1.67 | 1.01 | 0.18 | 1.75 |
| | PGA/PLA | | | | |
| | A/PLA B | | | | |

Conditions Table for Example 2

| | | Temperature, | Rel. Humidity, | Flow Rate, |
|---|---|---|---|---|
| Gas | Condition | ° C. | % | SCCM |
| Water | Tropical | 38 | 90 | 100 |
| Water | Summer | 30 | 80 | 100 |
| | Warehouse | | | |
| Water | Supermarket | 23 | 50 | 100 |
| Oxygen | Standard | 23 | 0 | 10 |

In one embodiment of the invention disclosed herein, a composite packaging structure comprising a paper layer laminated with a PGA layer is constructed utilizing extrusion coating processes as are known in the art. The paper and PGA structure may also be constructed using a plastic film of monolayer PGA or a multi-layer coextruded film with PGA as one of the exterior layers of the film, which can be manufactured by known cast or blown film methods. The polymers which may be used in the manufacture of this composite structure include PLA, aliphatic polyester, and other blended polymers. The paper layer and PGA layer are then combined together using lamination extrusion or adhesion lamination processes to form the composite paper and PGA packaging structure. In other embodiments, a metal barrier layer or a silica primer or barrier layer may be applied to form an optional barrier or primer layer to the paper and PGA composite structure. In one embodiment of the present invention, a composite paper-based structure utilizes bio-based or compostable (defined by ASTM D6400) polymers as filler, primer, and/or heat seal layers. In one embodiment, where the filler also functions as the primer layer, it has been discovered that such a three layer structure is capable of imparting adequate barrier properties to the paper for food packaging use.

FIG. 3 illustrates one embodiment of a composite paper-based packaging structure 300 as described herein. As shown in FIG. 3, ink layer 312 is printed on paper layer 314. Adhesive layer 316 is interposed between paper layer 314 and barrier layer 318. Primer layer 320 is utilized to promote bonding of barrier layer 318 with filler layer 322. Paper layer 324 to which filler layer 326 is laminated, co-extruded or otherwise coated is depicted which all together comprise composite paper packaging structure 300. In this embodiment, ink layer 312 is printed on a surface of paper layer 314. Ink layer 312 comprises any generally known printing inks suitable for use in food packaging applications. Adhesive layer 316 is applied to the opposing surface of paper layer 314 to which barrier layer 318 adheres. Barrier layer 318 may comprise aluminum, silica, foil or other suitable metal or metalloid barrier. Optional primer layer 322 may be applied to filler layer 322 as desired to promote bonding between primer layer 320 and barrier layer 318. Primer layer 320 may be applied to paper layer 322 via CCVD or PECVD processes or by other traditional primer application coating processes as known in the art. Primer layer 320 may also be applied to paper layer 322 via CCVD or PECVD processes at open atmosphere as is known in the art.

In various embodiments, the present invention reduces the amount of material required to provide a paper-based film with barrier properties. When the filler layer also functions as the primer layer, only three layers are required to impart adequate barrier properties to the paper. For example, various structural embodiments of the flexible composite packaging structure disclosing the use of paper and starch, along with other potential embodiments, are described in Table 4. For reference, as the packaging structure elements are read from left to right, the left most layer of the packaging composite is exposed to the exterior environment while the right most layer is exposed to the interior environment or product side of the package.

TABLE 4

| | |
|---|---|
| 3-A | Ink/Starch/Paper |
| 3-B | Ink/Starch/Paper/Starch |
| 3-C | Ink/Starch/Paper/Starch/Sealant |
| 3-D | [SiO(x)]/Ink/Starch/Paper |
| 3-E | [SiO(x)]/Ink/Starch/Paper/Starch/Sealant |
| 3-F | [Al(2)(O)(3)]/Ink/Starch/Paper |
| 3-G | [Al(2)O(3)]/Ink/Starch/Paper/Starch |
| 3-H | [Al(2)O(3)]/Ink/Starch/Paper/Starch/Sealant |
| 3-I | Ink/Paper/Adhesives/Foil/Starch/Paper/Starch |
| 3-J | Ink/Paper/Adhesives/Foil/Starch/Paper/Starch/Sealant |
| 3-K | Ink/Paper/Adhesives/Foil/Starch/Paper/Sealant |
| 3-L | Ink/Paper/Adhesives/Metalized Layer/Starch/Paper/Starch |
| 3-M | Ink/Paper/Adhesives/Metalized Layer/Starch/Paper/Starch/Sealant |
| 3-N | Ink/Paper/Adhesives/Metalized Layer/Starch/Paper/Sealant |

As described in Table 4, the symbol [SiO(x)] represents a silica layer which has been deposited as a primer or barrier layer via CCVD or PECVD, or as is known in the art and/or described herein. In certain embodiments, the silica layer is deposited as a primer or barrier layer via CCVD or PECVD at open atmosphere. The symbol [Al(2)O(3)] represents an alumina layer which has been deposited as a barrier layer via conventional metallization, CCVD or PECVD, or as is known in the art and/or described herein. In various embodiments, the alumina layer is deposited as a barrier layer via CCVD or PECVD at open atmosphere. The term “Starch” refers to the use of thermoplastic starch resins which contain a plasticizer such as glycerin, to enable the starch to process similar to a plastic resin, and which may be reactively extruded with other compounds to improve thermal stability. The term “Adhesives” represents solvent based adhesives such as polyvinyl acetate, hot melt adhesives such as ethylene-vinyl acetate, or solventless adhesives such as polyurethanes. The term “Ink” represents any commercially available printing inks which may be utilized for printing packaging in the food packaging context. The term “Paper” refers to any paper substrate such as Kraft paper, coated papers, magazine or photographic paper, or other cellulosic pulp based papers which are commercially available, and paper structures that are treated with standard practice in the paper industry, such as with calendaring or machine glazed, for improved surface smoothness. The term “Sealant” is used to refer to a sealant layer or “heat seal” layer which may be formed from PHA, aPLA, wax, starch, PGA, PBS, aliphatic polyester and/or commercially available sealants such as ECOFLEX and ECOVIO, which are compostable polyesters manufactured by BASF. The heat seal surface may also employ heat seal promoters to increase the heat seal strength and temperature sealing range. The various structural configurations of the paper-based packaging composites disclosed in Table 3 include structures with paper and starch (Structures 3-A through 3-C), structures with paper, starch and a metallization primer or barrier layer (Structures 3-D through 3-E), structures with paper, starch and a metal oxide primer or barrier layer (Structures 3-F through 3-H), structures with paper, starch and a foil barrier layer (Structures 3-I through 3-K) and structures with paper, starch and a metallized barrier layer (Structures 3-L through 3-N).

In certain disclosed embodiments, the invention described herein is a multi-layer flexible packaging comprising: (a) a paper layer; (b) a filler layer applied to at least one surface of the paper layer for smoothing at least one surface of the paper layer; and (c) an optional primer layer deposited on the filler layer surface wherein the primer facilitates metallization of the flexible packaging. In certain disclosed embodiments, the invention described herein is a multi-layer flexible packaging comprising: (a) a paper layer; (b) an optional ink layer deposited on a first side of the paper layer; and (c) a polyglycolic acid (PGA) layer deposited on a second side of the paper layer. In certain disclosed embodiments, the invention described herein is a method of manufacturing a multi-layer flexible packaging comprising: (a) applying a filler layer to a paper layer to smooth at least one surface of the paper layer; and (b) depositing a primer layer on to the filler layer.

Unless otherwise defined, all technical and scientific terms used herein have the same meaning as commonly understood by one of ordinary skill in the art to which this invention belongs. All referenced cited herein are incorporated by reference; however, in case such references conflict with the present disclosure, including references within the priority documents, the present disclosure controls. While this invention has been particularly shown and described with reference to a preferred embodiment, it will be understood by those skilled in the art that various changes in form and detail may be made therein without departing from the spirit and scope of the invention.

What is claimed is:

1. A multi-layer, flexible packaging comprising:
a paper layer;
a filler layer applied to at least one surface of the paper layer for smoothing at least one surface of the paper layer; and,
an optional primer layer deposited on the filler layer surface wherein the primer enhances the wettability of the primed surface.

2. The flexible packaging of claim 1 wherein the paper is one selected from the group of kraft paper, coated paper or cardboard paper stock.

3. The flexible packaging of claim 1 wherein the filler is one selected from the group of PET, PHA, PLA, PGA, aliphatic polyester, EVOH, PVOH, aPVOH, amorphous nylon, EAA, aPET, PETG, kaolinite, talc, mica, mordenite, vermiculite, titanium dioxide and calcium carbonate and blends thereof.

4. The flexible packaging of claim 1 wherein the primer is one selected from the group of a metal, metal oxide, silica, EAA, EVOH, PVOH, epoxy, maleic anhydride, EMA, PEI and EVA.

5. The flexible packaging of claim 1 further comprising a sealant layer wherein the sealant is selected from the group of a PHA, PBS, aPLA, wax, starch, PGA, and aliphatic polyester.

6. The flexible packaging of claim 1 further comprising an ink layer.

7. The flexible packaging of claim 1 further comprising a barrier layer.

8. The flexible packaging of claim 7 further wherein the barrier layer is one selected from the group of inorganic metal oxide, metal, alumina, silica, foil, PVDC, EVOH, PVOH, EAA, PMMA, polyacrylic acid, polycyanacrylate, hydroxyethyl methacrylate and polyethyl methacrylate.

9. The flexible packaging of claim 1 further comprising an adhesive layer is one selected from the group of a polyvinyl dichloride (PVDC), polyvinyl acetate, ethylene-vinyl acetate, or polyurethanes.

10. The flexible packaging of claim 1 wherein the filler comprises a binder.

11. The flexible packaging of claim 1 wherein the primer layer is applied by one of CCVD or PECVD at open atmosphere.

12. The flexible packaging of claim 7 wherein the barrier layer is applied by one of CCVD or PECVD at open atmosphere.

13. The flexible packaging of claim 1 wherein the flexible packaging is substantially compostable.

14. The flexible packaging of claim 1 wherein the flexible packaging is substantially recyclable.

15. A multi-layer flexible packaging comprising:
a paper layer;
an optional ink layer deposited on a first side of the paper layer; and,
a polyglycolic acid (PGA) layer deposited on a second side of the paper layer.

16. The flexible packaging of claim 15 wherein the paper is one selected from the group of a kraft paper, a coated paper, or a cardboard paper stock.

17. The flexible packaging of claim 15 further comprising a primer layer.

18. The flexible packaging of claim 17 wherein the primer layer is one selected from the group of a metal, metal oxide, silica, EAA and PVOH.

19. The flexible packaging of claim 15 further comprising an adhesive layer is one selected from the group of a polyvinyl acetate, ethylene-vinyl acetate, or polyurethanes.

20. The flexible packaging of claim 15 further comprising a sealant layer is one selected from the group of a PBS, PHA, aPLA, wax, starch, PGA, aliphatic polyester, ECOFLEX and ECOVIO and blends thereof.

21. The flexible packaging of claim 15 further comprising a barrier layer.

22. The flexible packaging of claim 21 wherein the barrier layer is one selected from the group of an inorganic metal oxide, metal, alumina, silica, foil, PVDC, EVOH, PVOH, EAA, PMMA, polyacrylic acid, polycyanacrylate, hydroxymethyl methacrylate and polyethyl methacrylate.

23. The flexible packaging of claim 15 further comprising a filler layer is one selected from the group of EVOH, nylon, PVOH, aPET, PETG, aPET, aPVOH, PVDC, EAA and PGA.

24. The flexible packaging of claim 17 wherein the primer layer is applied by one of CCVD or PECVD at open atmosphere.

25. The flexible packaging of claim 21 wherein the barrier layer is applied by one of CCVD or PECVD at open atmosphere.

26. The flexible packaging of claim 15 wherein the flexible packaging is substantially compostable.

27. The flexible packaging of claim 15 wherein the flexible packaging is substantially recyclable.

28. A method for manufacturing a multi-layer flexible packaging comprising:
applying a filler layer to a paper layer to smooth at least one surface of the paper layer;
depositing a primer layer on to the filler layer.

29. The method of claim 28 wherein the filler layer is one selected from the group of PET, PHA, PLA, PGA, aliphatic polyester, EVOH, PVOH, aPVOH, amorphous nylon, EAA, aPET, PETG, kaolinite, talc, mica, mordenite, vermiculite, titanium dioxide and calcium carbonate and blends thereof.

30. The method of claim 28 wherein the filler layer and paper layer are laminated by application of a binder.

31. The method of claim 30 wherein the binder is one selected from the group consisting of waxes, starches, vinyls, acrylics proteins and latex.

32. The method claim 28 wherein the primer layer is deposited by one of CCVD, PECVD, CCVD at open atmosphere, PECVD at open atmosphere, solution coating, Mayer rod or Gravure.

33. The method of claim 28 further comprising:
printing an ink layer on to at least one surface of the paper layer.

34. The method of claim 28 further comprising:
depositing a barrier layer on to the surface of the primer layer.

35. The method of claim 28 further comprising:
applying a sealant layer.

36. The method of claim 34 wherein the barrier layer is deposited by one of evaporation, sputtering, CVD, CCVD, PECVD, CCVD at open atmosphere, PECVD at open atmosphere, as a solution coating, by Mayer rod or Gravure, vacuum deposition, flame deposition and flame hydrolysis.

37. The method of claim 34 wherein the barrier layer is one selected from the group of metal oxide, metalloids, PVDC, EVOH, PVOH, EAA, acrylics, PMMA, polyacrylic acid, polycyanacrylate, hydroxyethyl methacrylate, and polyethyl methacrylate.

38. The method of claim 28 wherein the primer layer is one selected from the group of metal, metal oxide, silica, EAA, PVOH, amorphous PVOH, epoxy, maleic anhydride, EMA, PEI and EVA.
